(19) United States
(12) Patent Application Publication
(10) Pub. No.: US 2015/0115792 A1
(43) Pub. Date: Apr. 30, 2015

(54) LUMINOUS ELECTRIC WIRE

(71) Applicant: YFC-BONEAGLE Electric Co., Ltd., Taoyuan County (TW)

(72) Inventors: Liang-Hsu KUO, Taoyuan County (TW); Ying-Ming KU, Taoyuan County (TW)

(73) Assignee: YFC-BONEAGLE Electric Co., Ltd., Taoyuan County (TW)

(21) Appl. No.: 14/067,271

(22) Filed: Oct. 30, 2013

(51) Int. Cl. H01B 7/00; H01B 7/02; H01B 1/02; H01B 3/30

(52) U.S. Cl. CPC H01B 7/00; H01B 3/30; H01B 7/0275; H01B 1/026
USPC 313/483

(57) ABSTRACT

The present invention relates to a luminous electric wire comprising at least one conductor component and an outer sheath for surrounding the conductor component. The outer sheath has at least one recess. The recess is filled with luminous materials. Under the natural light, the fluorescent light and ultraviolet, the luminous electric wire of the present invention stores energy. After stop receiving the light illumination, the luminous materials with energy stored irradiate slowly in a form of fluorescence, which is visible in the night or the darkness and lasts for several hours or more than ten hours, which prevents people from accidents caused by stumbling in the darkness

### BACKGROUND OF THE INVENTION

1. Field of the Invention

The present invention relates to an electric wire, in particular relates to a luminous electric wire.

2. Description of Related Art

The electric wires for conducting electric currents are generally applied in the fields of electric power, the telecommunication and in associate with the electric current transfer. In many places, there are multiple electric wires installed in pipelines with weak lighting or without lighting, for example electric wires in the mine pits or tunnels, and along the subways. It is always difficult to find and differentiate between wires during maintenance of electric wires in the dark.

Currently, luminous electric wires outer sheath with luminous pigments are available in the market. The method of manufacturing luminous electric wires involves with mixing the plastic resins, plastic additives and luminous powders, and processed by an extruding processing. The luminous pigments contain rare earth elements, and are easily contaminated by metals then turning darkened. Such luminous pigments have insufficient irradiating effects and fail to provide required irradiating levels.

### SUMMARY OF THE INVENTION

The objective of the present invention is to provide a luminous electric wire which is visible in the night or darkness.

In order to achieve the above objective, the present invention provides a luminous electric wire comprising at least one conductor component surrounded by an outer sheath, wherein the outer sheath has at least one recess filled with luminous materials.

In an embodiment according to the present invention, the shape of the recess is a stripe along the direction of the length of the luminous electric wire. In another embodiment, the shape of the recess is a spiral stripe, along the direction of the length of the luminous electric wire. In another embodiment, the shape of the recess is a semi-sphere.

In an embodiment according to the present invention, the outer sheath comprises plastic resins and plastic additives. The plastic resins are PVC, PE, PP, PS and PC. The plastic additives comprise stabilizers, plasticizers and flame retardants. In another embodiment, the outer sheath further comprises luminous pigments, and the outer sheath is an extruding layer. The color of the luminous pigments of the outer sheath and the color of the luminous materials filled in the recess are different. The coating is an extruding layer manufactured by extruding molding. The percentages of the luminous pigments and the plastic resins are 2 wt %-10 wt %.

In an embodiment according to the present invention, the luminous pigments are enveloped in a film. In an embodiment according to the present invention, the luminous materials in the recess comprises luminous powders, wherein the luminous powders preferably are enveloped in a film.

Additionally, the present invention provides a method for manufacturing a luminous electric wire. The plastic resins and plastic additives are added to the mixers according to a specific percentage. A mixture A is obtained after high speed blending. A part of the mixture A and a definite quantity of the luminous powders enveloped in a film are mixed at low speed and a mixture B is obtained. The mixture B is put into a two screw-spindle extruding machine to produce mother particles by extruding and granulating. After the mother particles are mixed evenly with a definite quantity of resins, the resins and the mother particles are put to the first charging opening of the profile extruding machine for manufacturing luminous materials used in the outer sheath recess by extruding molding. The mixture A without the luminous mother particle is put to the second charging opening of the profile extruding machine at the same time for manufacturing the outer sheath having recess on the surface by extrusion.

The luminous pigments and luminous powders used in the luminous electric wire according to the present invention are enveloped in a film, for avoiding the luminous pigments and luminous powders from contaminating by metals, and facilitating the luminous electric wire to achieve ideal luminous effects. Under the natural light, the fluorescent light and ultraviolet, the luminous electric wire of the present invention stores energy. After stop receiving the light illumination, the luminous materials with energy stored irradiate slowly in a form of fluorescence, which is visible in the night or the darkness and lasts for several hours or more than ten hours, which prevents from accidents caused by stumbling in the darkness.

### BRIEF DESCRIPTION OF DRAWING

The novel features of the invention are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a cross section schematic diagram of a luminous electric wire having an outer sheath with luminous materials of two long stripes according to an embodiment of the present invention;

FIG. 2 is a perspective schematic diagram of the luminous electric wire of FIG. 1;

FIG. 3 is a cross section schematic diagram of a luminous electric wire having an outer sheath with luminous materials of multiple long stripes according to another embodiment of the present invention;

FIG. 4 is a cross section schematic. diagram of a luminous electric wire having an outer sheath with luminous materials of spiral stripes according to the other embodiment of the present invention; and

FIG. 5 is a cross section schematic diagram of a luminous electric wire having an outer sheath with luminous materials of circle dots according to the other embodiment of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

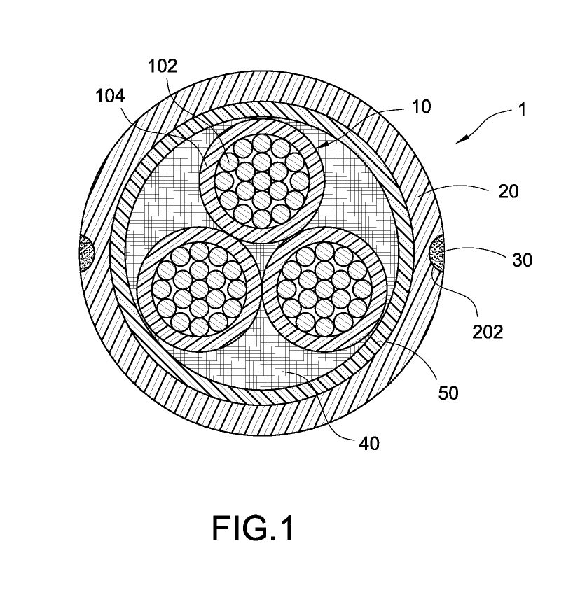

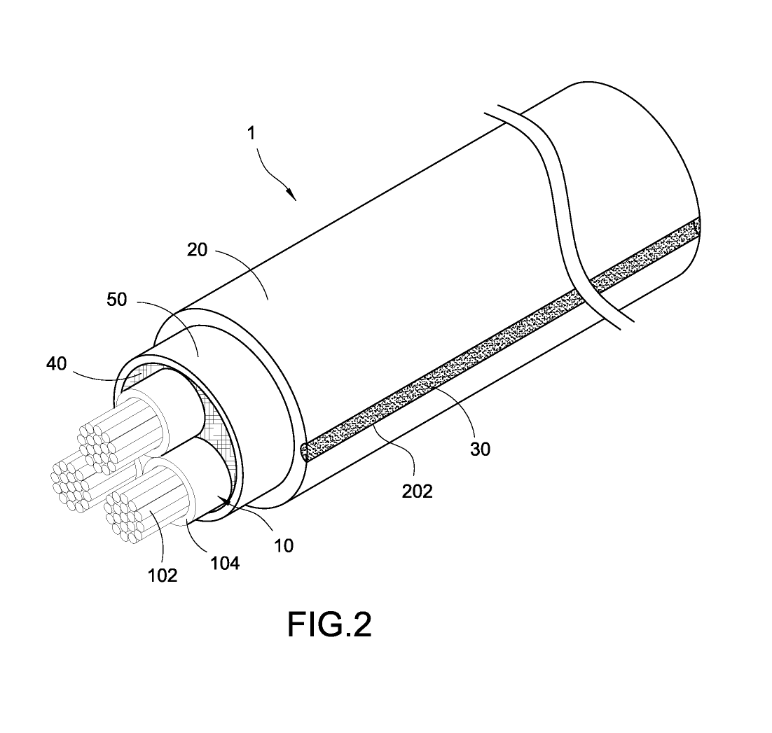

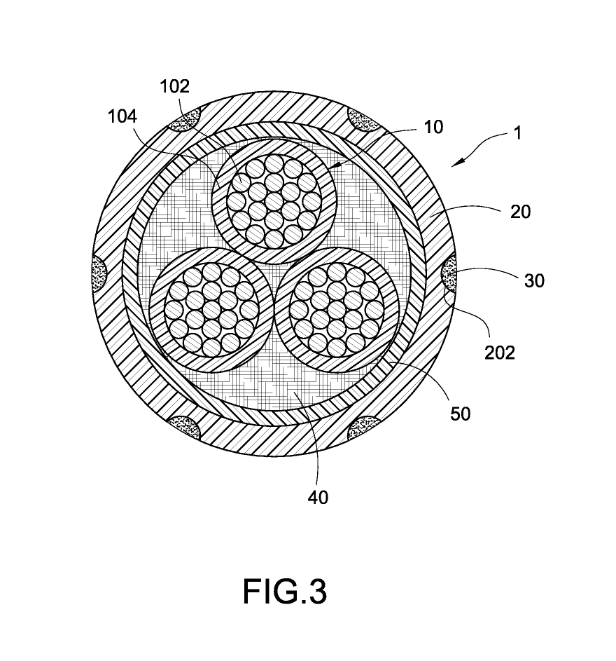

FIG. 1 s across section schematic diagram of a luminous electric wire coated with luminous materials of two long stripes according to an embodiment of the present invention and FIG. 2 is a perspective schematic diagram of the luminous electric wire of FIG. 1. According to the present invention, the luminous electric wire 1 comprises three conductor components 10 and an outer sheath 20 for surrounding the conductor components 10. The outer sheath 20 has two recesses 202. The recesses 202 are filled with luminous materials 30. According to the present invention, the recesses 202 are stripes along the direction of the length of the luminous electric wire 1. The conductor component 10 comprises copper conducting wires 102a and an insulating layer 104 for surrounding the copper conducting wires 102. Three conductor components 10 are fixed by fastening member 40. In addition, the luminous electric wire 1 of the present invention alternatively comprises an isolation layer 50 between the conductor component 10 and the outer sheath 20. In order to make the luminous materials 30 more visible, the outer sheath 20 further installs more recesses 202 which receives more luminous materials filled in the recesses 202 as shown in FIG. 3.

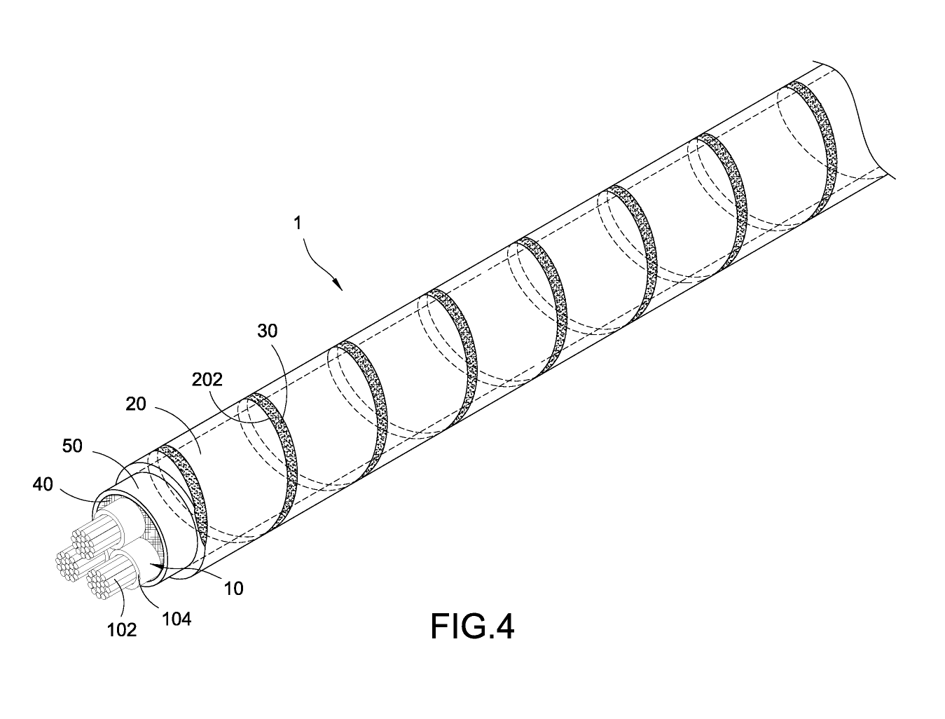

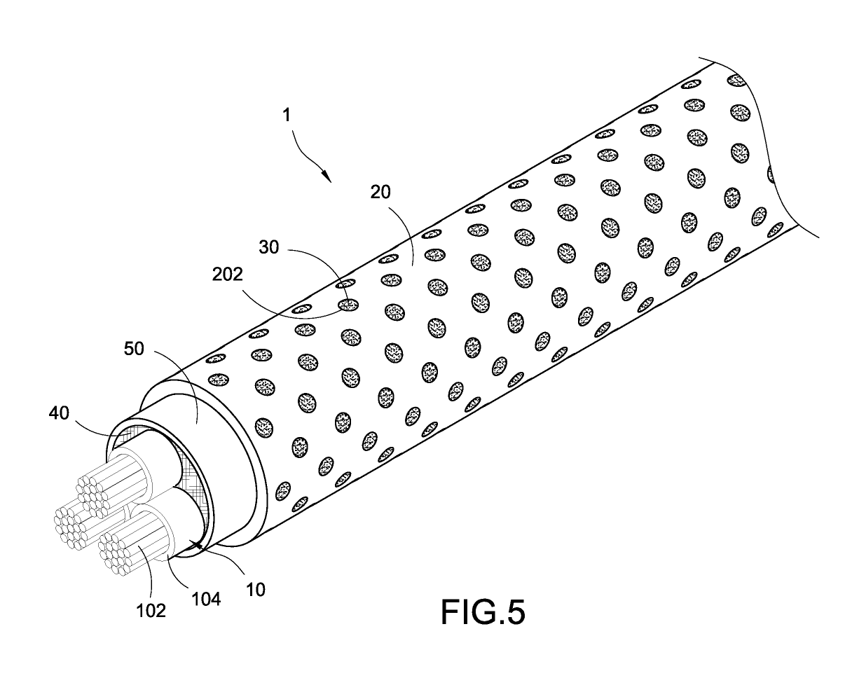

In the other embodiment, the shape of the recess 202 of the present invention is a spiral stripe along the direction of the length of the luminous electric wire as shown in FIG. 4. In another embodiment, the recess 202 of the present invention is a semi-sphere as shown in FIG. 5.

The method of manufacturing luminous electric wires is illustrated below. The manufacturing method comprises steps: mixing materials, granulating and extruding. In the mixing step, the plastic resins and additives are added to the mixing machine by percentage and mixed under high speed and the mixing is stopped when the temperature raises to 50˜80° C. Consequently, a mixture A is obtained after the resins and the additives are mixed evenly. A part of the mixture A and a definite quantity of luminous powders enveloped in a filmare mixed evenly with low speed for enabling the luminous powders to stick to the surface of the resins evenly in order to obtain the mixture B. In the granulating step, the mixed mixture B is put into a two screw-spindle extruding machine for performing extruding and granulating. After the materials are extruded from the opening of the machine head, the extruded materials a d by water and granulated to generate mother particles for preceding the following steps. In the extruding step, the prepared mother particles and a definite quantity of resins are mixed evenly to add to the first charging opening of the profile extruding machine, and the luminous materials forming in the recess of the outer sheath are extruded. The mixture A without the luminous mother particles is added to the second charging opening of the profile extruding machine, and the outer sheath having the recesses formed in the surface is extruded.

### Embodiment 1

100 kg of the PVC resin, 3 kg of the calcium/zinc stabilizer, 21 kg of the DOTP, and 21 kg of the DOA and 10 kg of the phosphoric ester flame retardant and are prepared and mixed with high speed for 30 minutes to obtain the mixtureA. Next, 78 kg of the mixture A and 5 kg of the luminous powders enveloped in a film are prepared and mixed with low speed for 10 minutes. The materials are extruded from the mixing machine after the luminous powders stick to the resin particles evenly in order to obtain the mixture B. The mixture B is added to the two screw-spindle extruding machine and keep the working temperature at 180˜220° C. The extruding granulating step is performed, where the materials are extruded from the machine head, the extruded materials are cooled by water and granulated to generate mother particles for preceding the following steps. 10 kg of the mother particle and 10 kg of the PVC resin are mixed evenly, adding the above mixed materials to the first charging opening of the profile extruding machine, and the luminous materials forming in the recess of the outer sheath are extruded. The mixture A without the luminous mother particles is added to the second charging opening of the profile extruding machine, and the outer sheath having the recesses formed in the surface is extruded.

### Embodiment 2

100 kg of the PVC resin, 3 kg of the calcium/zinc stabilizer, 21 kg of the DOTP, and 21 kg of the DOA and 10 kg of the phosphoric ester flame retardant are prepared and mixed at a high speed for 30 minutes to obtain the mixture A. Then 50 kg of the mixture A and 3 kg of yellow green light luminous powders enveloped in a film are prepared and mixed in a low speed for 10 minutes. Extruding the materials from the mixing machine after the luminous powders stick to the resin particles evenly in order to obtain the mixture B. 50 kg of the mixture A and 3 kg of blue green light luminous powders enveloped in a filmare prepared and mixed in a low speed for 10 minutes. The materials are discharged from the mixing machine after the luminous powders stick to the resin particles evenly in order to obtain the mixture C.

The mixture B is added to the two screw-spindle extruding machine and the working temperature is kept at 180˜220° C., The extruding granulating step is performed, where the materials are extruded from the machine head, the extruded materials are cooled by water and granulated to generate mixture B mother particles for preceding the following steps. Additionally, The mixture C is added to the two screw-spindle extruding machine and the working temperature is kept at 180˜220° C. The extruding granulating step is performed, where the materials are extruded from the machine head, the extruded materials are cooled by water and granulated to generate mixture C mother particles for preceding the following steps.

10 kg of the mixture B mother particle and 10 kg of the PVC resin are mixed evenly and added into the first charging opening of the profile extruding machine, and the luminous materials for filling into the recess of the are extruded. 10 kg of the mixtureC mother particle and 50 kg of the PVC resin are mixed evenly and put into the second charging opening of the profile extruding machine at the same time, and the outer sheath having recesses on the surface is extruded.

In the mixtures, phosphoric flame retardants are used, for example liquid phosphoric ester flame retardants, which may provide good flame retardance and suited for using in resins such as PVC and synthetic rubbers in order to increase the flame resistance and the plasticity, and phosphoric flame retardants do not include halogens. Additionally, the terephthalate plasticizers (DOTP) used in the mixtures have good heat resistance, good electricity tolerance, low volatility, good compatibility, and are particularly suitable to use in high insulative PVC cable products (70-90° C.). DOA is a typical industrial plasticizer which has good cold tolerance, high heating plasticizing efficiency, and low thermochromatism. The products made with DOA have good flexibility in low temperature and lightfastness. The luminous electric wires of the present invention may completely comply with ROHS & REACH environmental requirements.

The luminous pigments and luminous powders used in the luminous electric wire according to the present invention are enveloped in a film, for avoiding the luminous pigments and luminous powders from contaminating by metals, and facilitating the luminous electric wire to achieve ideal luminous effects. Under the natural light, the fluorescent light and ultraviolet, the luminous electric wire of the present invention stores energy. After stop receiving the light illumination, the luminous materials with energy stored irradiate slowly in a form of fluorescence, which is visible in the night or the darkness and lasts for several hours or more than ten hours, which prevents people from accidents caused by stumbling in the darkness.

As the skilled person will appreciate, various changes and modifications can be made to the described embodiments. It is intended to include all such variations, modifications and equivalents which fall within the scope of the invention, as defined in the accompanying claims.

What is claimed is:

1. A luminous electric wire, comprising at least one conductor component and an outer sheath for surrounding the conductor component, the outer sheath having at least one recess, the recess is filled with luminous materials.

2. The luminous electric wire of claim 1, wherein the shape of the recess is a stripe along the direction of the length of the luminous electric wire.

3. The luminous electric wire of claim 1, wherein the shape of the recess is a spiral stripe along the direction of the length of the luminous electric wire.

4. The luminous electric wire of claim 1, wherein the shape of the recess is a semi-sphere.

5. The luminous electric wire of claim 1, wherein the outer sheath comprises plastic resins and plastic additives.

6. The luminous electric wire of claim 5, wherein the plastic resins are PVC, PE, PP, PS and PC.

7. The luminous electric wire of claim 5, wherein the plastic additives comprise stabilizers, plasticizers and flame retardants.

8. The luminous electric wire of claim 5, wherein the outer sheath further comprises luminous pigments, and the outer sheath is an extruding layer.

9. The luminous electric wire of claim 8, wherein the color of the luminous pigments and the color of the luminous materials filled in the recess are different.

10. The luminous electric wire of claim 8, wherein the luminous pigments are enveloped in a film.

11. The luminous electric Wire of claim 8, wherein the percentages of the luminous pigments and the plastic resins are 2 wt %-10 wt %.

12. The luminous electric wire of claim 1, wherein the luminous materials comprises luminous powders.

13. The luminous electric wire of claim 12, wherein the luminous powders are enveloped in the film.
